(19) United States
(12) Patent Application Publication
(10) Pub. No.: US 2018/0086612 A1
(43) Pub. Date: Mar. 29, 2018

(54) Lift Device for HVAC Unit

(71) Applicant: Tobler Ken, Lenoir City, TN (US)

(72) Inventor: Tobler Ken, Lenoir City, TN (US)

(21) Appl. No.: 15/714,805

(22) Filed: Sep. 25, 2017

Related U.S. Application Data
(60) Provisional application No. 62/398,954, filed on Sep. 23, 2016.

(51) Int. Cl. B66F 9/06

(52) U.S. Cl. CPC B66F 9/06; F24F 13/32

(57) ABSTRACT

An apparatus is disclosed for lifting, supporting, and rolling a commercial HVAC unit or other large appliance device relative to a work site and while the work site is being prepared for installation. The apparatus includes two rail assemblies with support braces or attached hooks that can be used to support the weight of the appliance. The rail assemblies can be carried to a rooftop or other installation location manually using a ladder or other elevating device. The hooks may also be rotated such that the lifting apparatus can be raised by a crane or other device. Each rail assembly also includes adjustable legs which can be moved up or down by rotating a hand operated crank.

### CROSS-REFERENCE TO RELATED APPLICATION

This application claims benefit of U.S. Provisional Application No. 62/398,954, filed on Sep. 23, 2016.

### FIELD OF THE INVENTION

This invention relates to the field of devices used for lifting, supporting, and transporting large commercial appliances such as HVAC units during installation.

### BACKGROUND

Prior art for this type of lifting apparatus is described in U.S. Patent Application Publication 2014/0140795, for example. This type of prior art transporting apparatus comprises two support frame assemblies, each having telescopic legs attached to wheels and upper support brackets from which the appliance unit is suspended, and which are connected by a removable frame connector. The apparatus may then be rolled across a rooftop to move and place the appliance unit.

This type of prior art lifting machine does not provide functionality to adjust the height of the assembly with an attached appliance load, but rather appears to require separate means for lifting the appliance, such as by crane or helicopter. While a crane will frequently be used to remove old appliances and lift new appliances on top of the roof during installation, the intent is to eliminate the need for the crane during the remainder of the installation period. The costs associated with providing crane or helicopter means are prohibitive and require minimizing their utilization as much as possible.

This invention has been invented in reference to the prior art problems.

Accordingly, a technical problem to be resolved by this invention is to provide a lightweight, portable appliance lifting device that can raise and lower heavy appliances, and minimize the necessity for a crane, helicopter, or other costly lifting device.

### BRIEF SUMMARY OF THE INVENTION

According to one embodiment of the present invention, an HVAC or other appliance lifting device comprising: at least a first rail assembly and a second rail assembly configured to support the weight of the said HVAC or other appliance; at least two legs attached to each of the at least first and second said rail assembly; at least one wheel attached to each of the said at least two legs configured to allow for movement of the lifting device by an operator; at least one support brace attached to each of the at least first and second said rail assembly, wherein said at least one support brace is configured to support the weight of the said HVAC or other appliance; and a jack or other device attached to each of the said at least two legs that is configured to raise or lower each of the at least first and second said rail assembly.

Example embodiments of the current invention include a method of moving an HVAC or other appliance during installation or service, said method comprising the steps of: providing at least a first rail assembly and a second rail assembly configured to support the weight of the said HVAC or other appliance; providing a jack or other device attached to at least two legs of the said at least first and second said rail assembly that is configured to raise or lower each of the at least first and second said rail assembly; adjusting a height of said at least first and second said rail assembly with said jack; adjusting a spacing between said at least first and second said rail assembly; holding the at least first and second said rail assembly in an upright position with at least one support brace attached to the at least first and second said rail assembly; loading the HVAC or other appliance onto the at least one support brace attached to the at least first and second said rail assembly; securing the each of the at least first and second said rail assembly to said HVAC or other appliance; and moving said at least first and second said rail assembly and said said HVAC or other appliance into a desired position.

### BRIEF DESCRIPTION OF THE DRAWINGS

The above-mentioned features of the invention will become more clearly understood from the following detailed description of the invention read together with the drawings in which:

FIG. 1 is a perspective view of one rail assembly of the HVAC or other appliance lifting device, legs, support brace and wheels.

FIG. 2 is a break out view of the crank arm, leg, wheels, pin and attachment device, with the leg in the upright position.

FIG. 3 is a break out view of the crank arm, leg, wheels, pin and attachment device, with the leg in the horizontal, rest position.

FIG. 4 is a front elevation view of the HVAC or other appliance lifting device with two rail assemblies, showing the legs in upright position awaiting loading of the HVAC or other HVAC or other appliance.

FIG. 5 is a front elevation view of the HVAC or other appliance lifting device with two rail assemblies, showing the legs in upright position with the HVAC or other HVAC or other appliance loaded.

### DETAILED DESCRIPTION OF THE INVENTION

Reference will now be made to the example embodiments of the present general inventive concept, examples of which are illustrated in the accompanying drawing(s) and illustration(s). The example embodiments are described herein in order to explain the present general inventive concept by referring to the figure(s). The following detailed description is provided to assist the reader in gaining a comprehensive understanding of the structures described herein. Accordingly, various changes, modification, and equivalents of the structures and techniques described herein will be suggested to those of ordinary skill in the art. The descriptions are merely examples, however, and the sequence type of operations is not limited to that set forth herein and may be changed as is known in the art, with the exception of operations necessarily occurring in a certain order. Also, description of well-known functions and constructions may be omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

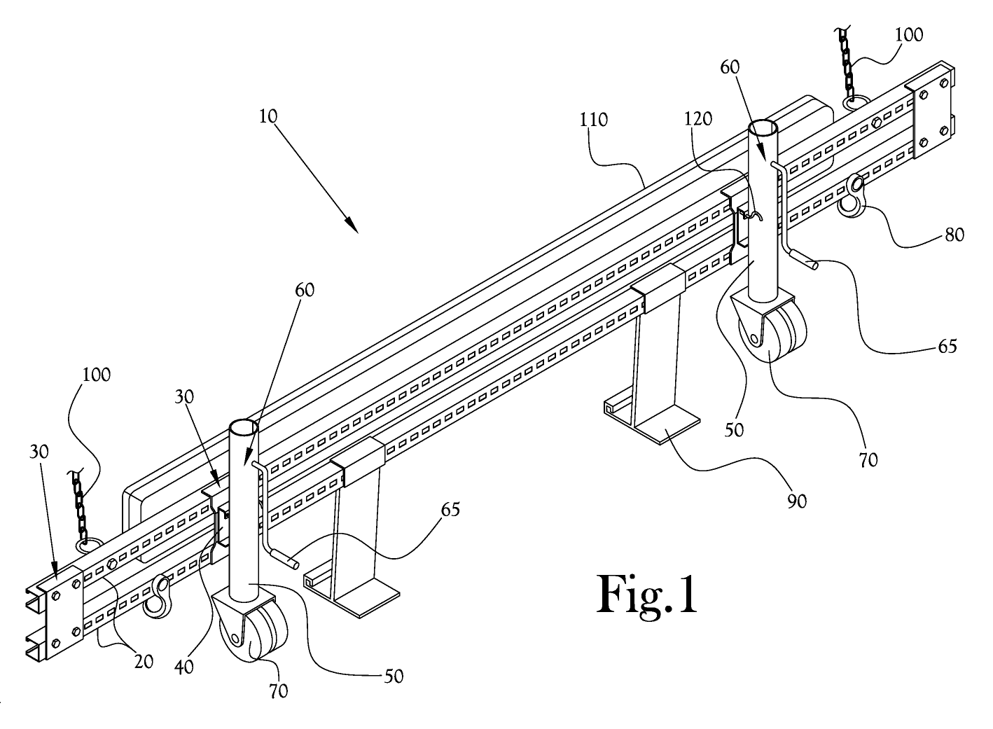

One of the rail assemblies 10 of an HVAC or other appliance 130 lifting device is shown in FIG. 1. The assembly may comprise two struts 20 coupled together with at least two attachment braces 30, which can be constructed of steel, aluminum, titanium, or other materials. The struts 20 shown are ten feet long and are one and five eighths inches square, although struts of different dimensions could be used depending on the weight of the HVAC or other appliance 130 to be lifted or lowered. The struts 20 may be constructed of steel, aluminum, titanium, or other materials. Attached to at least two of the attachment braces 30 is a rotatable bracket 40, each of which may support a leg 50. The legs 50 may rotate 360 degrees in an orientation parallel to the plain of the two struts 20. In FIG. 1, the legs 50 are shown both in an upright position, although the legs 50 may be rotated ninety degrees, and in a horizontal position, for storage of the HVAC or other appliance 130 lifting device. Each leg 50 may be manually raised or lowered. Depicted in FIG. 1 is a jack 60 with crank arm 65 attached for manual adjustment of the rail assembly 10 height. Alternatively, the jack 60 may include electromotive or hydraulic mechanism for raising and lowering each of the rail assemblies 10. Two wheels 70 may be attached to each leg 50 and the wheels can swivel freely 360 degrees, and move freely in a forward and rearward direction. The wheels 70 may include a locking device which can resist movement of the device during installation or removal of the HVAC or other appliance 130. The rail assembly 10 may include at least two hooks 80 for supplemental attachment of the HVAC or other appliance 130 to the rail assembly 10 for transport. The hook 80 may be attached to one of the struts 20 by means of a nut, bolt, and washer and can be moved laterally to any of the openings in the strut to accommodate attachment points on the HVAC or other appliance 130. Bolts, pins, or any other type of prior art attachment device could also be used.

Also shown in FIG. 1 are support braces 90 which may be slideably and removeably attached to one of the struts 20, and move in a lateral direction relative to the struts 20. The support braces 90 may function to support the HVAC or other appliance 130 and may additionally hold each rail assembly 10 in an upright fashion prior to the loading of the HVAC or other appliance 130 onto the rail assemblies 10. The support braces 90 can be constructed of steel, aluminum, titanium, or other materials. One or more chains 100 may be attached to the rail assemblies 10 in order to secure the HVAC or other appliance 130 to both rail assemblies 10 during transportation. A tensioning device (not shown) may be used to pull the chain into tension and lock the load down. A protective barrier 110 may be provided which may be attached to at least the top strut 20 and functions to rest against the side of the HVAC or other appliance 130 to provide stability during movement of the HVAC or other appliance 130 and protect the finish of the HVAC or other appliance 130 from abrasive contact with the struts 20. The protective barrier 110 may be a wood framing member, or may be made of rubber, plastic, carpet or other material which can protect the finish of the HVAC or other appliance 130.

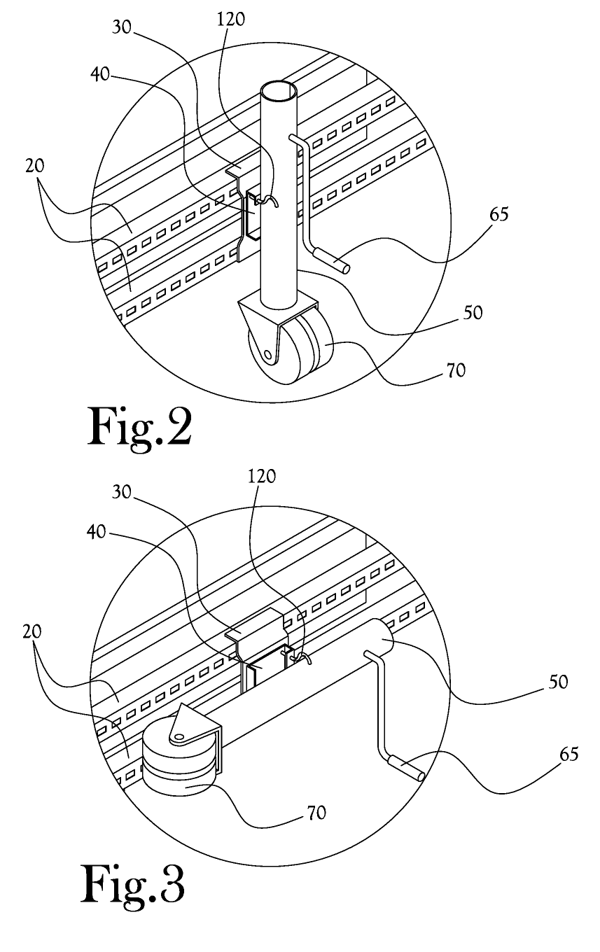

FIG. 2 shows a close up view of one of the legs 50 in the upright position. A pin 120 is shown attached to the rotatable bracket 40, which may be spring loaded, and may be manually retracted to release the rotatable bracket 40 from locked in engagement with the brace 30, so that the rotatable bracket 40 and leg 50 can be rotated to a full 360 degrees. Once the desired position has been realized, the operator may release a gripping device for the pin 120, tension in the spring may cause the pin 120 to reinsert itself in one of several holes in the brace 30, and the rotatable bracket 40 may be once again locked in position. Shown are two wheels 70 attached to each leg 50, although one or more wheels 70 may be utilized and the wheels 70 may be made of rubber, plastic or other suitable materials.

FIG. 3 shows a close up view of one of the legs 50 in a horizontal position, which can be used for storage of the rail assembly 10. In this case, the leg 50 has been rotated ninety degrees from its position in FIG. 2, by manually retracting the pin 120, to release the rotatable bracket 40 from locked in engagement with the brace 30. In this position, the leg 50 is in substantial alignment with the struts 20.

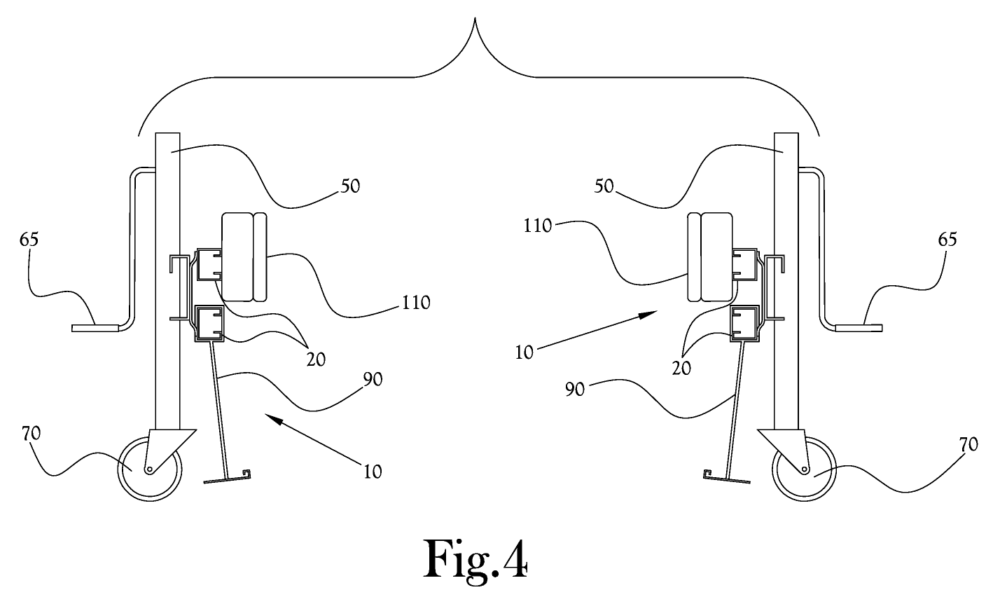

FIG. 4 shows a front view of two rail assemblies 10 in an upright position, awaiting loading of the HVAC or other appliance 130. The rail assemblies 10 may be supported by the two support braces 90 and two legs 50. In this position, the operator can manipulate the hand crank 65 to raise and lower the rail assemblies 10 by a desired amount, such that the rail assemblies 10, will be balanced and stable prior to loading of the HVAC or other appliance 130. Other methods could be used to raise and lower the legs including foot-operated pedals, or electrical, battery operated, or hydraulic actuators.

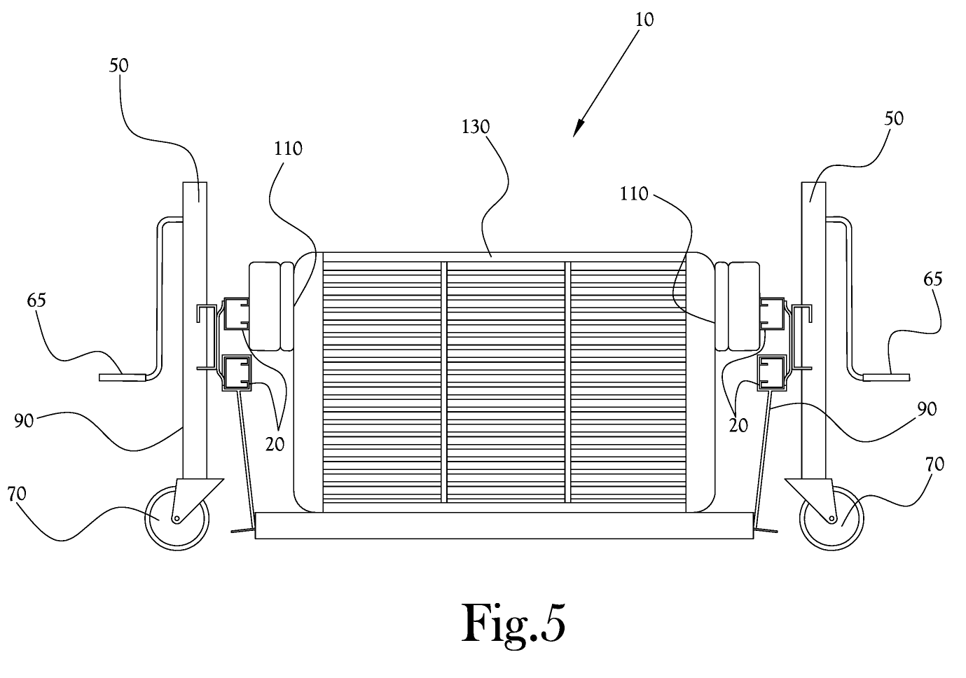

FIG. 5 shows a front view of two rail assemblies 10 in an upright position, after the HVAC or other appliance 130 has been loaded. From this viewpoint, it is possible to see the HVAC or other appliance 130 in position resting behind the two legs 50, in the foreground, with the two rear legs 50 hidden from view. The HVAC or other appliance 130 is shown resting on two support braces 90 although more than two support braces 90 may be utilized. Additionally, the HVAC or other appliance 130 is shown resting between the two protective barriers 110. The HVAC or other appliance 130 may also be supported by the hooks 80 shown in FIG. 1, or may rest directly on the struts 20. Chains 100 (not shown in FIG. 5) may be used to provide firm attachment between the two rail assemblies 10 and the HVAC or other appliance 130. A tensioning device (not shown) may be used to pull the chain into tension and lock the load down. Once the HVAC or other appliance 130 has been firmly attached to the rail assemblies 10, the operator may raise the rail assemblies 10 and HVAC or other appliance 130 by operating the hand cranks 65, until the rail assemblies 10 and HVAC or other appliance 130 are at a desired height. At this point, the rail assemblies 10 and HVAC or other appliance 130 may be moved.

An example embodiment of the invention can be described as follows. First, the operator can disconnect the old HVAC or other appliance 130. Next, a pair of rail assemblies 10 can be attached to the old HVAC or other appliance 130 and the old HVAC or other appliance 130 can be lifted from its bed and transported by the lift device to the side of the building. A crane may then be employed to remove the old HVAC or other appliance 130 from the roof and bring a new HVAC or other appliance 130 on the roof for installation. The new HVAC or other appliance 130 is lifted by means of the two rail assemblies 10, moved to its bed, and lowered into its bed. Once the old unit is removed from its bed, the bed can be prepared for the new installation.

In another example embodiment of the invention, an operator may adjust the height of a first and second said rail assembly 10 with a jack 60, until a desired height is reached. The operator may then adjust the spacing between the first and second said rail assembly 10 so that the spacing is generally the same as one of the dimensions of the HVAC or other appliance 130. While holding the first and second said rail assembly 10 in an upright position with at least one support brace 90 attached to the at least first and second said rail assembly 10, the operator may load the HVAC or other HVAC or other appliance 130 onto the at least first and second said rail assembly. The operator may then secure the first and second rail assembly 10 to said HVAC or other HVAC or other appliance 130. Finally, the first and second rail assembly 10 and HVAC or other appliance 130 may be moved into a desired position.

While there have been described what are considered to be preferred embodiments of the present invention, it will be readily appreciated by those skilled in the art that modifications can be made without departing from the scope of the teachings herein. Numerous variations, modification, and additional embodiments are possible, and, accordingly, all such variations, modifications, and embodiments are to be regarded as being within the spirit and scope of the present general inventive concept. While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

What is claimed is:

1. An HVAC or other appliance lifting device comprising:
at least a first rail assembly and a second rail assembly configured to support the weight of the said HVAC or other appliance;
at least two legs attached to each of the at least first and second said rail assembly;
at least one wheel attached to each of the said at least two legs configured to allow for movement of the lifting device by an operator;
at least one support brace attached to each of the at least first and second said rail assembly, wherein said at least one support brace is configured to support the weight of the said HVAC or other appliance; and
a jack or other device attached to each of the said at least two legs that is configured to raise or lower each of the at least first and second said rail assembly.

2. The lifting device according to claims 1, wherein said at least a first rail assembly and a second rail assembly comprises at least two steel, or other material, struts.

3. The lifting device according to claims 2, wherein said at least two struts are joined by at least two attachment braces.

4. The lifting device according to claims 1, wherein pins attached to each of the said at least two legs can be manually retracted such that the at least two legs are configured to rotate in a circumferential direction during storage of the lifting device.

5. The lifting device according to claims 1, wherein said at least one wheel moves in a forward and rearward direction and rotates freely.

6. The lifting device according to claim 5, wherein said at least one wheel includes a locking device for resisting movement of the lifting device during installation or removal of said HVAC or other appliance.

7. The lifting device according to claims 1, wherein said at least one support brace is configured to be moveable in a lateral direction.

8. The lifting device according to claims 1, wherein said at least one support brace is configured to support the said at least first rail assembly and second rail assembly prior to loading of said HVAC or other appliance.

9. The lifting device according to claims 1, wherein said jack includes a crank arm for manually raising and lowering each of the at least first and second said rail assembly.

10. The lifting device according to claims 1, wherein said jack includes an electromotive or hydraulic mechanism for raising and lowering each of the at least first and second said rail assembly.

11. The lifting device according to claims 1, including a hook or other attachment device on each of the at least first and second said rail assembly configured to provide supplemental support to said HVAC or other appliance.

12. The lifting device according to claims 1, including chains or other mechanism attached to each of the at least first and second said rail assembly configured to secure each of the at least first and second said rail assembly to said HVAC or other appliance during movement.

13. The lifting device according to claims 1, including a protective barrier attached to each of the at least first and second said rail assembly configured to protect a surface of said HVAC or other appliance during movement.

14. The lifting device according to claims 13, wherein said protective barrier comprises a wood framing member.

15. A method of moving an HVAC or other appliance during installation or service, said method comprising the steps of:
providing at least a first rail assembly and a second rail assembly configured to support the weight of the said HVAC or other appliance;
providing a jack or other device attached to at least two legs of the said at least first and second said rail assembly that is configured to raise or lower each of the at least first and second said rail assembly;
adjusting a height of said at least first and second said rail assembly with said jack;
adjusting a spacing between said at least first and second said rail assembly;
holding the at least first and second said rail assembly in an upright position with at least one support brace attached to the at least first and second said rail assembly;
loading the HVAC or other appliance onto the at least one support brace attached to the at least first and second said rail assembly;
securing the each of the at least first and second said rail assembly to said HVAC or other appliance; and
moving said at least first and second said rail assembly and said said HVAC or other appliance into a desired position.
